(19) United States
(12) Patent Application Publication
(10) Pub. No.: US 2026/0208131 A1
(43) Pub. Date: Jul. 23, 2026

(54) BONE ADHESIVE APPLICATOR

(71) Applicant: INSTITUT STRAUMANN AG, Basel (CH)

(72) Inventors: Ole ZOFFMANN ANDERSEN, Basel (CH); Benjamin BELLON PECECNIK, Basel (CH); Birgit RENGGLI, Basel (CH); Robert KEANE, Basel (CH); Francisco FAORO, Basel (CH)

(73) Assignee: INSTITUT STRAUMANN AG, Basel (CH)

(21) Appl. No.: 19/142,570

(22) PCT Filed: Dec. 21, 2023
(86) PCT No.: PCT/EP2023/087211

§ 371 Date: Jun. 23, 2025

(30) Foreign Application Priority Data
Dec. 21, 2022 (EP) 22215581.4

(51) Int. Cl. B01F 27/054; A61C 19/00; B01F 27/1125; B01F 27/118; B01F 31/441; B01F 33/501; B01F 35/00; B01F 35/71; B01F 35/75; B01F 101/19; B01F 101/20

(52) U.S. Cl. CPC B01F 27/0543; A61C 19/005; B01F 27/1125; B01F 27/118; B01F 31/441; B01F 33/50111; B01F 35/562; B01F 35/7174; B01F 35/754251; B01F 2101/19; B01F 2101/20

(57) ABSTRACT

A dental bone adhesive applicator for mixing at least two components of a bone adhesive and applying the bone adhesive is described, including a housing with a longitudinal axis and an outlet, a mixing compartment arranged in the housing and in fluidic communication with the outlet, an axially movable plunger arranged in the housing and axially delimiting the mixing compartment opposite to the outlet, a mixer configured to mix the two components of the bone adhesive in the mixing compartment, wherein the mixer comprises a collapsible mixing head and a connector connected to the collapsible mixing head, wherein the connector includes a drive interface.

### FIELD OF THE INVENTION

The present invention relates to a bone adhesive applicator for mixing at least two components of a bone adhesive and applying the bone adhesive, and a method for preparing a bone adhesive.

### BACKGROUND OF THE INVENTION

The use of a bone adhesive to glue implants in place may be considered as a favorable advancement in the field of implantology. Together with the ability to robustly bond to mineralized bone tissue and/or to metal, a suitable bone adhesive can act as an initial implant stabilization glue with reduced detrimental effect on the bone while placing of the implant.

Typically, a bone adhesive comprises at least one dry component which is mixed with a liquid prior to application. Since after mixing of the dry component with the liquid, the bone adhesive hardens within a rather short time scale on the order a few minutes, the dry component has to be kept separate from the liquid until mixing can be performed shortly before application of the bone adhesive.

A package Comprising a device for storing, mixing, and administering an adhesive composition is for example described in WO 2021/041943 A1. The device comprises a chamber within a main body, a barrier, a plunger, a nozzle, and an adhesive composition, wherein the package limits ingress of a contaminating element. The device may comprise a first chamber and a second chamber separated by the barrier, wherein components of the composition may be provided as dry components, such as powder or granules within the first chamber and the second chamber may comprise an aqueous medium, such as water. Specifically, pressure is applied to the plunger of the device to breach the barrier, allowing the components of the adhesive composition to come into contact with each other. The device is then placed into an agitator to agitate the contents of the device, thereby preparing the adhesive composition. The chamber in which the components of the composition are mixed can be swept by a plunger that empties the chamber by expressing the chamber contents out through an orifice of the main body to an application site, such as bone, or into a nozzle through which the resulting implantable composition flows to an application site, such as bone.

### SUMMARY OF THE INVENTION

When using a bone adhesive to glue an implant at an application site, it is desired to provide the one or more dry components separate from the liquid component before mixing. After bringing the one or more dry components into contact with the liquid component, it is further desired to provide an efficient mixing of the components, preferably shortly before application of the bone adhesive. For implants in the oral cavity, i.e. dental implants, respectively, mixing the bone adhesive can particularly challenging due to the small amounts of bone adhesive involved therewith.

It is therefore an object of the invention to provide a bone adhesive applicator for mixing at least two components of a bone adhesive and applying the bone adhesive, and a method for preparing a bone adhesive, which at least partially improve the prior art and avoid at least part of the disadvantages of the prior art.

According to the present invention, this object is achieved by the features of the independent claims. In addition, further advantageous embodiments follow from the dependent claims and the description as well as the figures.

According to an aspect of the invention, this object is particularly achieved by a bone adhesive applicator for mixing at least two components of a bone adhesive and applying the bone adhesive, comprising a housing with a longitudinal axis and an outlet, a mixing compartment arranged in the housing and in fluidic communication with the outlet, an axially movable plunger arranged in the housing and axially delimiting the mixing compartment opposite to the outlet, a mixer configured to mix the two components of the bone adhesive in the mixing compartment, wherein the mixer comprises a collapsible mixing head and a connector connected to the collapsible mixing head, wherein the connector comprises a drive interface.

The collapsible mixing head provides the advantage that the spatial extent of the mixing head can be varied, for example depending on the specific state of operation of the bone adhesive applicator. While mixing the components of the bone adhesive for example, it may be favorable if the mixing head exhibits a certain spatial extent throughout or reaching into the mixing compartment in order to provide efficient mixing of the components of the bone adhesive. While applying the bone adhesive, on the other hand, it may be favorable if the mixing head exhibits a small spatial extent in axial direction in order to e.g. enable the plunger to advance in the housing towards the outlet and to convey the bone adhesive out of the mixing compartment.

This may particularly be advantageous for implants in the oral cavity where typically only small amounts of bone adhesives are used. In some embodiments, the bone adhesive applicator according to the present disclosure is therefore a dental bone adhesive applicator for mixing at least two components of a dental bone adhesive and applying the dental bone adhesive. In particular, the mixing head may provide efficient mixing of a bone adhesive where the volume of the liquid is smaller than the volume of the dry component of the bone adhesive.

In the context of the present disclosure, the term “bone adhesive” shall be understood to comprise not only an adhesive such as a bone glue, but also or alternatively a bone cement. In particular, the bone adhesive may be a composition which is configured to create a bond between bone and bone and/or bone and implant.

The mixing head may be driven by a drive which can be connected to the drive interface of the connector. The drive may be used to rotate and/or vibrate the mixing head such that an efficient mixing of the components of the bone adhesive can be provided.

The mixing head may be manually collapsible by manual movement of the mixer. For example, the mixing head may be moved such that the mixing head abuts against a part of the housing or the outlet which causes the mixing head to collapse thereafter.

In some embodiments, the mixing head may be collapsed by a movement of the mixer driven by a drive connected to the drive interface. For example, the mixing head may be collapsed by a rotational movement of the mixer induced by a drive.

Preferably, the mixing head is collapsible in a reversible manner. In some embodiments, however, the mixing head may be collapsible in a non-reversible manner.

The mixing head may be expandable or re-expandable, respectively, especially after being collapsed. The mixing head may manually be expandable by manual movement of the mixer. For example, the mixing head may be expanded by moving away from a part of the housing or the outlet. In some embodiments, the mixing head may be expanded by a movement of the mixer driven by a drive connected to the drive interface. For example, the mixing head may be expanded by a rotational movement of the mixer induced by a drive.

In some embodiments, the expandability of the mixing head may rely on the resilience of the mixing head, for example for a mixing head comprising a spring.

With the collapsible mixing head, a bone adhesive applicator can be provided which is compact and where the mixer can be adapted to the specific state of operation of the bone adhesive applicator. Further, the bone adhesive applicator provides the advantage of integrability where mixing of the components of the bone adhesive and delivery, or application of the bone adhesive, respectively, can be performed by the same device. This may particularly be advantageous for application in dental implantology where small amounts of dental bone adhesive are involved and, in particular, where the volume of the liquid may be smaller than the volume of the dry component of the bone adhesive. Integrability may increase reliability and ease of use especially for dental surgeons preparing and applying the bone adhesive using the dental bone adhesive applicator. Further, integrability provides the advantage that the requirements of sterility and time restrictions due to hardening can be satisfied.

The one or more dry components of the bone adhesive may be in the form of a powder. In particular, the bone adhesive may be a dual part composition comprising an aqueous solution as first component and a self-setting adhesive powder as second component, wherein said self-setting adhesive powder comprises at least a multivalent metal salt and phosphoserine. The multivalent metal salt may comprise calcium phosphate, for example tetra calcium phosphate (TTCP) or tri calcium phosphate (TCP), preferably α-TCP. The self-setting adhesive powder may comprise 50-80% by weight of TCP or TTCP, phosphoserine and preferably further components like calcium silicate. Preferably, the self-setting adhesive powder comprises 65 to 80% by weight of α-TCP, 20-30% by weight of phosphoserine and 1 to 5% by weight of calcium silicate. The bone adhesive may be formed by mixing the first component and the second component and allowing the obtained composition sufficient time to set. Initial setting may typically be achieved within 15 seconds and 90 seconds, and final setting may typically be achieved within 1 to 15 minutes.

Preferably, a smaller amount, especially volume, of liquid may be used for the bone adhesive than the amount, especially volume, of the dry component of the bone adhesive. In some embodiments, the volume ratio of the liquid used for the bone adhesive to the dry component of the bone adhesive used may be between 1:3 and 1:6.

The mixing compartment being axially delimited by an axially movable plunger provides the advantage that the volume of the mixing compartment may be varied. Besides advancing the plunger to convey the bone adhesive out of the mixing compartment, the plunger may also be moved towards the outlet in order to reduce the volume of the mixing compartment. The dental bone adhesive applicator may therefore accommodate a volume decrease of the mixture of the components of the bone adhesive, which may for example cur upon contact or mixing of the different components of the bone adhesive, by appropriate movement of the plunger.

In some embodiments, the collapsible mixing head is collapsible in radial direction of the housing.

The spatial extent of the mixing head in radial direction, i.e. transverse to the longitudinal axis of the housing, may therefore be varied. By collapsing the mixing head in radial direction, the mixing head may fit into or through parts of the housing with a reduced cross-section, which may be advantageous when applying the bone adhesive. Accordingly, the mixing head may also be expandable in radial direction, which may be beneficial for achieving efficient mixing of the components of the bone adhesive. Radial collapsibility and/or expandability of the mixing head may be controlled or induced, respectively, by rotational motion of the mixer around a longitudinal axis of the connector. In particular, radial collapsibility and/or expandability of the mixing head may be controlled or induced by centrifugal forces generated by rotational motion of the mixer.

In some embodiments, the collapsible mixing head comprises a brush, the brush preferably comprising bristles made of a biodegradable material.

By using a brush with flexible bristles, collapsibility of the mixing head can be achieved in a simple manner. In particular, the brush may comprise a shaft with bristles mounted thereon such that the bristles may be bended against the shaft, thereby enabling the mixing head to radially collapse. Resilient bristles may further enable the mixing head to re-expand after being collapsed.

Bristles made of a biodegradable material provide the advantage that bristles which may detach from the brush while mixing may biodegrade when being applied together with the bone adhesive. In some embodiments, the bristles may be made of chitosan.

In some embodiments, the connector is guided through the outlet such that the drive interface is arranged outside of the housing.

Guiding the connector through the outlet such that the drive interface is arranged outside of the housing provides the advantage that the opening in the housing provided by the outlet can be used to connect a drive to the drive interface of the connector. For example, a drive of a dental handpiece may be connected to the drive interface.

The bone adhesive applicator may comprise one or more dry components contained in the mixing compartment. By pulling the plunger, a liquid or aqueous component, such as water, may be drawn into the mixing compartment through the outlet.

In some embodiments, the liquid component may be supplied by a reservoir with a reservoir plunger, where the reservoir plunger may push the liquid component out of the reservoir and into the mixing compartment.

After supplying the liquid component, the mixing head and part of the connector may be introduced into the mixing compartment through the outlet. After mixing the bone adhesive, the mixing head and part of the connector may be removed from the mixing compartment, such that the bone adhesive may be applied through the outlet by advancing the plunger towards the outlet.

By using a radially collapsible mixing head, e.g. a brush, introducing and removing the mixing head through the outlet, which has a smaller cross-section than the housing, can be enabled while providing efficient mixing within the mixing compartment by re-expanding the mixing head after passage through the outlet.

In some embodiments, the collapsible mixing head is arranged within the mixing compartment.

By arranging the mixing head within the mixing compartment, efficient mixing of the components of the bone adhesive may be achieved. As described above, this may particularly be advantageous for a dental bone adhesive applicator where a small amount of bone adhesive is used, especially where the volume liquid is smaller than the volume of the dry component of the bone adhesive.

In some embodiments, the collapsible mixing head is collapsible in axial direction of the housing.

A mixing head being collapsible in axial direction may be particularly advantageous for conveying the bone adhesive out of the mixing compartment if the mixing head is positioned within the mixing compartment while applying the bone adhesive.

Due to the axial collapsibility of the mixing head, the range across which the plunger can advance in the housing towards the outlet can be increased, such that a larger portion of the bone adhesive can be conveyed out of the mixing compartment. Thus, a reliable delivery of the bone adhesive can be provided without having to remove the mixing head before application of the bone adhesive.

In particular, the mixing head may be collapsible by movement of the plunger towards the outlet and expandable by movement of the plunger away from the outlet.

In embodiments where the mixing head is collapsible in a non-reversible manner, the mixing head may be collapsible by movement of the plunger towards the outlet.

The spatial extent of the mixing head in axial direction, i.e. along the longitudinal axis of the housing, may therefore at least partially be coupled to the position of the plunger within the housing.

Accordingly, the mixing head may contribute to efficient conveying of the bone adhesive out of the mixing compartment by being collapsed when the plunger is moved towards the outlet.

On the other hand, an expanded configuration of the mixing head may be restored when moving the plunger away from the outlet in order to enable efficient mixing of the components of the bone adhesive.

Coupling of the spatial extent of the mixing head in axial direction with the position of the plunger provides the advantage that the mixing head can adapt to the volume of the mixing compartment. This may in particular be advantageous if the components change their volume upon being brought into contact with each other. For example, a decrease in volume may occur if one or more of the dry components are brought into contact with the liquid component. A decrease in volume may then be accommodated by the plunger moving in the direction towards the outlet such that the mixing compartment is reduced in size. Due to the coupling of the axial spatial extent of the mixing head with the position of the plunger, the mixing head may at least partially be collapsed and thereby provide efficient mixing also for the reduced mixing compartment.

In some embodiments, the drive interface of the connector is arranged adjacent to a side of the plunger facing away from the mixing compartment.

A drive may therefore be connected to the drive interface from the side of the housing which is opposite to the outlet. The housing may comprise an opening on the side opposite to the outlet, such that the drive interface may be accessed through the opening. The drive interface may be arranged completely or partially within the housing. Arranging the drive interface within the housing provides the advantage that the drive interface can be protected from damage. Further, compactness of the bone adhesive applicator may be improved in this fashion.

In some embodiments, the bone adhesive applicator comprises a plunger rod configured to push the plunger towards the outlet. The plunger rod may comprise a recess configured to receive the drive interface and preferably a part of the connector adjacent to the drive interface.

After mixing of the components of the bone adhesive by driving the mixing head, the drive may be disconnected from the drive interface. The plunger may then be advanced by the plunger rod such that the bone adhesive may be conveyed out of the mixing compartment through the outlet.

In some embodiments, the plunger rod is releasably connectable to the plunger. The connection between the pusher rod and the plunger may for example be achieved by a thread, a snap-fit or one or more catches and notches.

The plunger and the plunger rod may be configured that the plunger may be advanced and retracted by the plunger rod.

In some embodiments, the plunger rod may comprise a drive which is connectable to the drive interface of the connector. The plunger rod may then be used both for driving the mixer and pushing and/or retracting the plunger.

In some embodiments, the plunger comprises a feedthrough for the connector.

In particular, the connector may comprise a shaft guided through the feedthrough, the shaft comprising a proximal end connected to the mixing head and a distal end connected to the drive interface, wherein the shaft is rotatable around its shaft axis.

The mixing head may therefore be rotated by rotating the shaft using the drive interface.

In some embodiments, the feedthrough is configured that the shaft is axially movable with respect to the plunger. This provides the advantage that the components of the bone adhesive may be mixed by repeatedly advancing and retracting the shaft and the mixing head, respectively, with respect to the plunger. Repeated collapsing and expanding of the mixing head within the mixing compartment may thereby provide efficient mixing of the components of the bone adhesive.

In some embodiments, the plunger comprises a sealing element arranged at the feedthrough. The sealing element may at least partially seal the feedthrough such that the components of the bone adhesive and/or the bone adhesive may not leak through the plunger or that leakage is reduced or minimized.

In some embodiments, the collapsible mixing head comprises a helical spring.

By using a helical spring, significant spatial collapsibility, especially in axial direction, can be provided together with effective mixing ability due to its helical structure.

The variability in structure of helical springs provides the advantage that the adaptability of the mixing head to specific shapes of the housing or the mixing compartment, respectively, of the dental bone adhesive applicator can be increased.

In some embodiments, the helical spring of the mixing head exhibits at least two different transverse diameters along its longitudinal spring axis.

By varying the transverse diameters of the helical spring, the helical spring can be collapsed to a smaller volume, since the wire portions of the helical spring can be arranged next to each other when the helical spring is being compressed. The collapsibility of the mixing head can therefore be improved.

In some embodiments, one or more portions of the helical spring exhibit a monotonously decreasing diameter towards the plunger or towards the outlet.

A monotonously varying diameter of the helical spring provides the advantage that the collapsibility of the mixing head can be improved.

In particular, one or more portions of the helical spring may exhibit a conical profile.

In some embodiments, the helical spring is a conical spring or a barrel spring.

In some embodiments, the mixing head is collapsible by rotation of the mixing head in a first direction and expandable by rotation of the mixing head in a second direction opposite the first direction.

Accordingly, the mixing head may be collapsed and expanded by a drive connected to the drive interface of the connector and configured to rotate the mixing head around a longitudinal connector axis. Alternatively or additionally, the mixing head may be manually collapsed and expanded by manually rotating the mixing head around a longitudinal connector axis.

In some embodiments, the mixing head comprises a turbine with blades which are switchable to an open configuration when the turbine rotates in the first direction and to a closed position when the turbine rotates in the second direction.

By rotating the turbine in the mixing head with the blades in the open configuration, a flow motion can be induced in the mixture of the one or more dry components and the liquid component, promoting the mixing of the components of the bone adhesive. Furthermore, the turbine provides the advantage that mixing of the components of the bone adhesive can be achieved without requiring the complete mixing head or a substantial portion of the mixing head to be arranged within the mixing compartment. Instead, the mixing head can be arranged at an end of the mixing compartment, which is beneficial when advancing the plunger through the housing towards the outlet for conveying the bone adhesive out of the mixing compartment.

In particular, the turbine may be configured as a plunger in the closed position of the blades, wherein the connector may comprise a rotatable shaft which is connected to the turbine in a manner to rotate the turbine and to move the turbine in axial direction.

In this way, a combined plunger and mixer unit may be provided. By rotating the shaft and the turbine in the first direction, the blades can be opened and the turbine be used for mixing. After mixing of the components of the bone adhesive, the shaft and the turbine may be rotated in the second direction such that the blades are closed and the turbine can be used as a plunger. The shaft can then be used to move the turbine with closed blades towards the outlet such that the bone adhesive is conveyed out of the mixing compartment.

The drive interface may be arranged at a distal end of the shaft. The turbine may be rotated by a drive connected to the drive interface.

In some embodiments, the drive interface of the bone adhesive applicator is configured for connection with a dental handpiece.

With the drive interface being connectable to a dental handpiece such that the mixer can be driven by a drive of the dental handpiece, operation of the bone adhesive applicator can substantially be facilitated, as no separate drive may be required and an existing dental handpiece can be used to drive the mixer.

As mentioned above, the bone adhesive applicator may further comprise a plunger rod which is releasably connectable to the plunger.

Further, the plunger rod may comprise a recess dimensioned to receive the drive interface and preferably a distal portion of the connector.

In some embodiments, the bone adhesive applicator comprises a cap configured to close the outlet. The cap may be removed in order to introduce a mixing head or a liquid component into the mixing compartment.

According to a further aspect, the present invention is also directed to a bone adhesive applicating system comprising the bone adhesive applicator as described in the present disclosure and a reservoir with a reservoir housing and a reservoir outlet, wherein the mixing compartment of the bone adhesive applicator comprises a bone adhesive powder, and the reservoir comprises a liquid, wherein the reservoir outlet is connectable to the outlet of the bone adhesive applicator, preferably by a thread.

In some embodiments, the reservoir comprises a reservoir plunger arranged in the reservoir housing. The liquid may then be pushed out of the reservoir and into the mixing compartment of the bone adhesive applicator by advancing the reservoir plunger towards the reservoir outlet.

Providing a reservoir with a reservoir plunger provides the advantage that the liquid can be pushed out of the reservoir instead of having to pull the liquid out of the reservoir.

Preferably, a smaller amount, especially volume, of liquid may be used for the bone adhesive than the amount, especially volume, of bone adhesive powder. In some embodiments, the volume ratio of the liquid used for the bone adhesive to the bone adhesive powder used may be between 1:3 and 1:6.

In some embodiments, the reservoir has a smaller volume than the mixing compartment when the liquid and the bone adhesive powder are separated.

The ratio of the volume of the reservoir to the volume of the mixing compartment when the liquid and the bone adhesive powder are separated may be between 1:3 and 1:6.

In some embodiments, the volume of the reservoir when the liquid and the bone adhesive powder are separated is between 100 μl and 150 μl.

According to a further aspect, the present invention is also directed to a method for preparing a bone adhesive, comprising the steps of: providing a bone adhesive applicating system as described in the present disclosure; supplying the liquid from the reservoir to the mixing compartment; connecting a drive to the drive interface of the connector; mixing the liquid with the bone adhesive powder in the mixing compartment by actuating the mixer using the drive.

In some embodiments of the method, the drive is a drive of a dental handpiece.

### BRIEF DESCRIPTION OF THE DRAWINGS

The present invention will be explained in more detail, by way of exemplary embodiments, with reference to the schematic drawings, in which:

FIG. 1 shows an embodiment of a bone adhesive applicating system with a bone adhesive applicator comprising one or more dry components and a reservoir comprising a liquid;

FIG. 2 shows the dental bone adhesive applicating system of FIG. 1 where the liquid from the reservoir has been supplied from the reservoir to the bone adhesive applicator;

FIG. 3 shows the dental bone adhesive applicating system of FIG. 2 while mixing of the components of the bone adhesive;

FIG. 4 shows the bone adhesive applicator of FIG. 3 with a plunger rod;

FIG. 5 shows the bone adhesive applicator of FIG. 4 with the plunger being advanced towards the outlet;

FIG. 6a-e show further embodiments of the helical spring of the mixing head;

FIG. 7 shows an embodiment of a bone adhesive applicator with a turbine;

FIG. 8a-b show the bone adhesive applicator of FIG. 7 with two different positions of the turbine within the housing;

FIG. 9 shows an embodiment of the bone adhesive applicator with a turbine;

FIG. 10 shows an embodiment of the bone adhesive applicator.

### DETAILED DESCRIPTION OF EXEMPLARY EMBODIMENTS

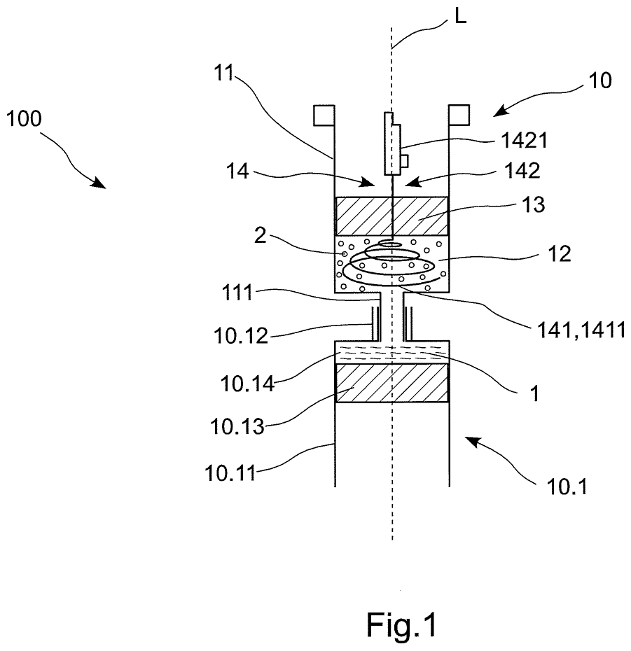

FIG. 1 shows an embodiment of a bone adhesive applicating system 100 with a bone adhesive applicator in an example of a dental bone adhesive applicator 10 and a reservoir 10.1. The bone adhesive applicator 10 comprises a housing 11 with a longitudinal axis L and an outlet 111. A mixing compartment 12 is arranged in the housing 11 and comprises one or more dry components 2. A plunger 13 which is movable along the longitudinal axis L delimits the mixing compartment 12 opposite to the outlet 111. The bone adhesive applicator 10 further comprises a mixer 14 with a mixing head 141 comprising a helical spring 1411 and a connector 142. The connector 142 comprises a drive interface 1421 configured for connection with a drive, especially with a drive of a dental handpiece. The drive interface 1421 is arranged at the side of the plunger 13 facing away from the outlet 111 and can therefore be accessed through the distal opening of the housing 11.

The reservoir 10.1 comprises a reservoir housing 10.11 with a reservoir outlet 10.12. The reservoir 10.1 further comprises an axially movable reservoir plunger 10.13 which axially delimits a liquid compartment 10.14 opposite to the reservoir outlet 10.12. The reservoir outlet 10.12 is connected to the outlet 111 by thread, establishing a fluidic communication between the liquid compartment 10.14 and the mixing compartment 12.

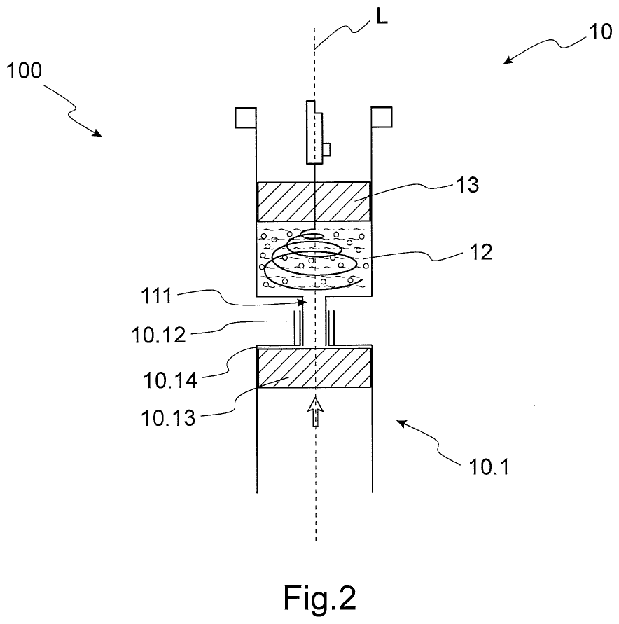

FIG. 2 shows the dental bone adhesive applicating system 100 of FIG. 1 where the liquid from the liquid compartment 10.14 of the reservoir 10. 1 has been pushed out from the liquid compartment 10.14 into the mixing compartment 12 of the dental bone adhesive applicator 10 by advancing the reservoir plunger 10.13 towards the reservoir outlet 10.12 (as symbolized by the arrow). Due to the additional volume brought in by the liquid, the plunger 13 is moved a by a certain distance away from the outlet 111, as compared to the situation in FIG. 1.

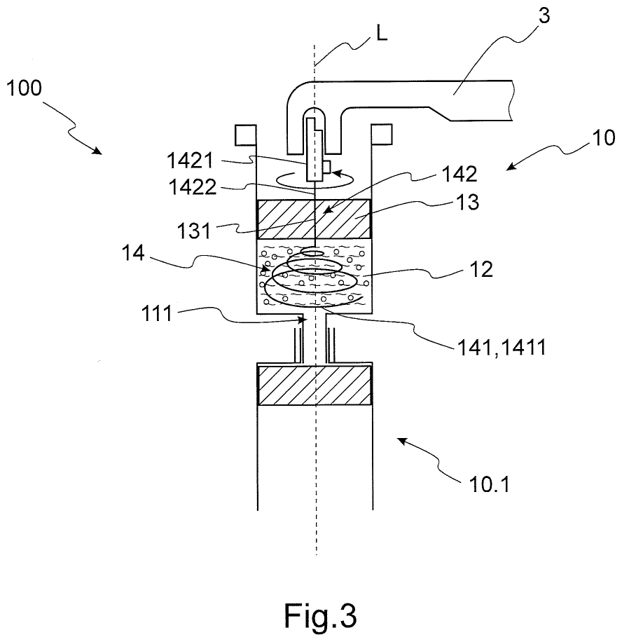

FIG. 3 shows the dental bone adhesive applicating system 100 of FIG. 2 while mixing of the components of the bone adhesive. A dental handpiece 3 is connected to the drive interface 1421 to drive the mixer 14 such that the mixing head 141 and the helical spring 1411, respectively, are rotated around the axis of the shaft 1422 of the connector 142 (as symbolized by the curved arrow). The shaft 1422 of the connector 142 is guided through a feedthrough 131 of the plunger 13. A sealing element (not shown in FIG. 3) is arranged at the feedthrough 131 such that the components of the bone adhesive do not leak out or only leak out by a small amount of the mixing compartment 12 through the plunger 13. The feedthrough 131 and the sealing element are dimensioned such that the shaft 1422 can rotate around its longitudinal axis.

As can be seen in FIG. 3, the reservoir 10.1 is kept connected to the dental bone adhesive applicator 10 while mixing of the components of the bone adhesive. It some embodiments, however, the outlet 111 may be closed by a cap during mixing.

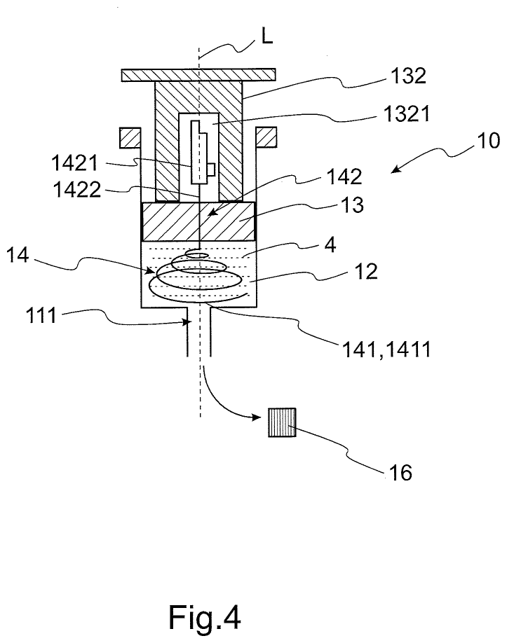

FIG. 4 shows the dental bone adhesive applicator 10 of FIG. 3 where the dental handpiece has been removed after mixing. Instead, a plunger rod 132 is arranged on the plunger 13 such that the dental bone adhesive 4 can be delivered through the outlet 111. The plunger rod 132 comprises a recess 1321 in which the drive 1421 and a distal portion of the shaft 1422 of the connector 142 is received.

In FIG. 4, the plunger rod 132 is shown to lie against the plunger 13 without mechanical connection with the plunger 13. In some embodiments, the plunger rod 132 may be releasably connected to the plunger 13 by for example a thread, a snap-fit connection, catches and/or notches etc. Different to FIG. 3, a cap 16 is shown which is used to close the outlet 111 while mixing and removed from the outlet 111 to enable to deliver the bone adhesive 4 through the outlet 111.

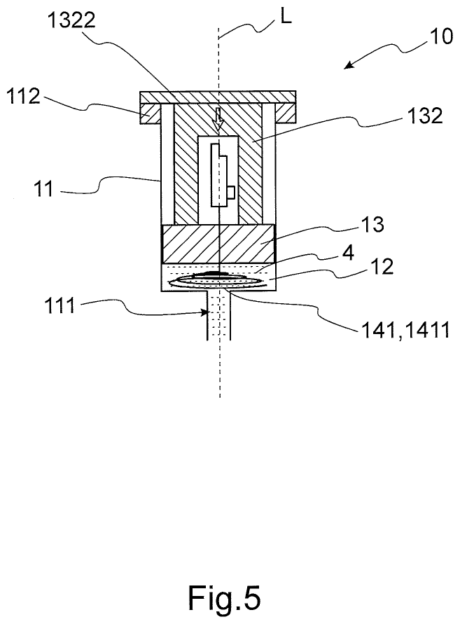

FIG. 5 shows the dental bone adhesive applicator 10 of FIG. 4 with the plunger 13 being advanced towards the outlet 111 (as symbolized by the vertical arrow). Compared to the configuration of FIG. 4, the helical spring 1411 of the mixing head 141 is collapsed in axial direction, i.e. along the longitudinal axis L, due to the movement of the plunger 13. The volume of the mixing compartment 12 is thereby reduced such that the bone adhesive 4 is conveyed out of the outlet 111 and can be applied to the site where a dental implant is to be positioned.

The housing 11 comprises a stop 112 extending around the circumference of the housing 11 and arranged at the distal end of the housing 11. The stop 112 is arranged such that a plate 1322 of the plunger rod 132 abuts against the stop 112 when the plunger 13 is advanced towards the outlet 111 such that a maximal advance of the plunger 13 is defined.

Due to the axial collapsibility of the helical spring 1411 and the mixing head 141, respectively, the reduction in volume of the mixing compartment 12 can be accommodated by the mixing head 141. It can also be recognized that the spring 1411 of the mixing head 141 ensures that the outlet 111 is not blocked and therefore the bone adhesive 4 can be conveyed out of the outlet 111 until the spring 1411 is completely collapsed. Comparing FIG. 5 and FIG. 4 further shows that the mixing head 141 and the spring 1411, respectively, may be (re) expanded by retracting the plunger 13 away from the outlet 111.

In FIGS. 1-5, embodiments are shown where the mixing head 141 comprises a helical spring in the form of a conical spring 1411.

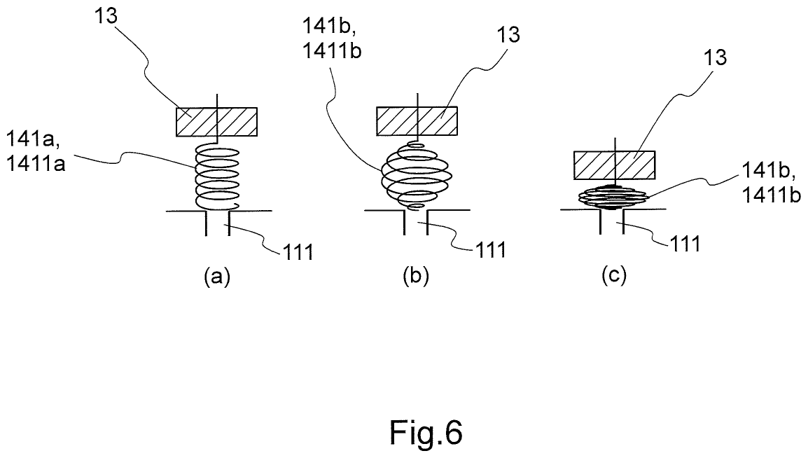

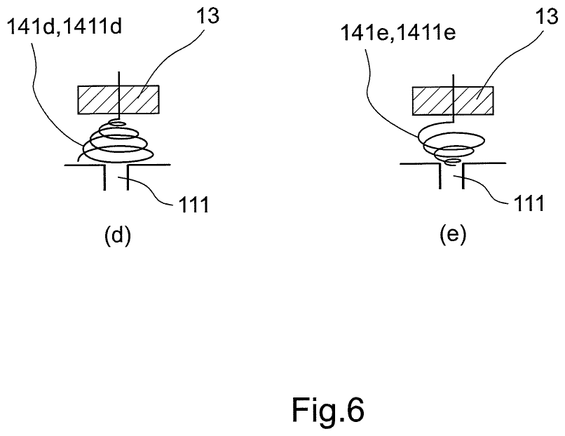

FIG. 6a shows a further embodiment of a mixing head 141a comprising a cylindrical spring 1411a arranged at a side of the plunger 13 facing towards the outlet 111.

FIG. 6b shows a further embodiment of a mixing head 141b comprising a barrel spring 1411b arranged at a side of the plunger 13 facing towards the outlet 111.

FIG. 6c shows the barrel spring 1411b of FIG. 6b in a collapsed state due to the plunger 13 being advanced towards the outlet 111. The barrel spring 1411b of the mixing head 141b as shown in FIGS. 6a and 6b provides the advantage that a tip region of the barrel spring 1411b may reach into the outlet 111 by which mixing of the components within the outlet 111 can be improved. Further, the volume of the mixing compartment may be reduced to a larger extent due to the tip region of the barrel spring 1411b of the mixing head 141b reaching into the outlet 111 while collapsing.

FIG. 6d shows a further embodiment of a mixing head 141d comprising a conical spring 1411d arranged at a side of the plunger 13 facing towards the outlet 111. The conical spring 1411d exhibits a monotonously decreasing diameter towards the plunger 13.

FIG. 6e shows a further embodiment of a mixing head 141e comprising a conical spring 1411e arranged at a side of the plunger 13 facing towards the outlet 111. The conical spring 1411e exhibits a monotonously decreasing diameter towards the outlet 111.

The skilled person understands that the cylindrical, barrel or conical spring as shown in FIGS. 6a-6e may also be used in the embodiment as shown in FIGS. 1-5.

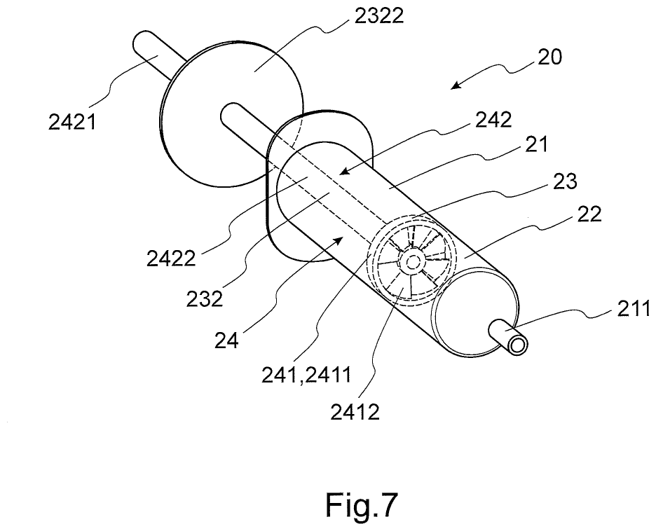

FIG. 7 shows an embodiment of a dental bone adhesive applicator 20 with a mixing head 241 comprising a turbine 2411. In FIG. 7, the blades 2412 of the turbine 2411 are in an open configuration. The mixer 24 further comprises a connector 242 with a shaft 2422 which is connected at a proximal end to the turbine 2411. At a distal end of the shaft 242, there is arranged a drive interface 2421. The shaft 242 may be rotated around its longitudinal axis by a drive connected to the drive interface 2421.

By rotating the shaft 242 and the turbine 2411, respectively, in a direction where the blades 2412 are in the open configuration, the components of the bone adhesive can be mixed in the mixing compartment 22 due to a flow motion induced by the turbine 2411. During mixing, a cap (not shown in FIG. 7) may be mounted onto the outlet 211 in order to avoid leaking of components of the bone adhesive.

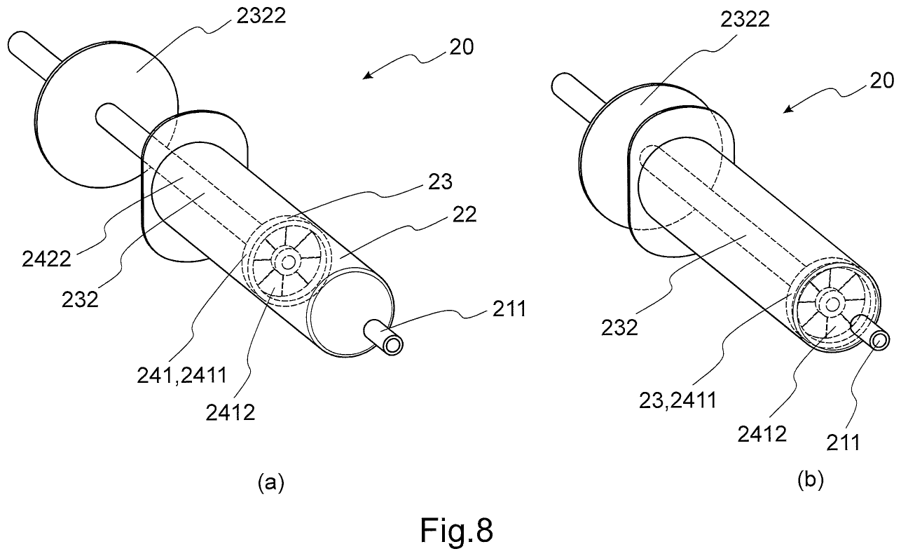

In a closed configuration of the blades 2412, the turbine 2411 is configured as a plunger 23, as described below in connection with FIG. 8a-b. Thus, the shaft 2422 may also act as a plunger rod 232.

In some embodiments, the shaft 2422 may be hollow and comprise a rotatable rod arranged within the shaft 2422, wherein the rotatable rod may be connected with the turbine 2411, such that the turbine 2411 may be rotated by the rotatable rod. The rotatable rod may be driven by a drive connected to the drive interface 2421.

FIG. 8a shows the dental bone adhesive applicator 20 of FIG. 7 with the blades 2412 switched into a closed configuration after mixing of the components of the bone adhesive. In the closed configuration of the blades 2412, the mixing head 241 with the turbine 2411 is operable as a plunger 23 configured to convey the bone adhesive out of the mixing compartment 22 through the outlet 211. The plunger 23 may be advanced by pushing of the shaft 2422 which acts as a plunger rod 232. The plunger rod 232 comprises a plate 2322 by which the plunger rod 232 can be pushed or retracted.

FIG. 8b shows the dental bone adhesive applicator 20 of FIG. 8b with the plunger 23 or the turbine 2411, respectively, being advanced towards the outlet 211, such that the bone adhesive is conveyed out of the dental bone adhesive applicator 20.

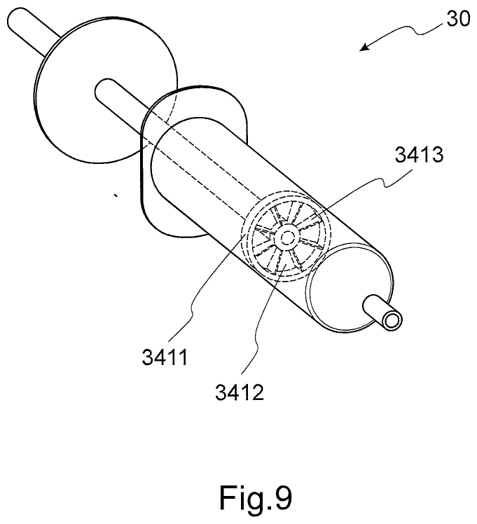

FIG. 9 shows a further embodiment of a dental bone adhesive applicator 30 with a turbine 3411. The structure of the dental bone adhesive applicator 30 corresponds to the dental bone adhesive applicator 20 shown in FIGS. 7-8, with the difference that the blades 3412 are embedded between bridges 3413. The bridges 3413 improve the stability of the turbine 3411 and the tightness of the blades 3412 in the closed configuration.

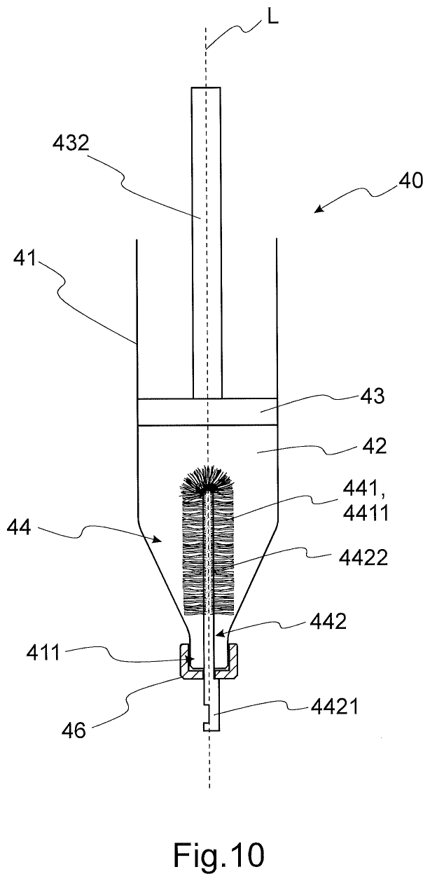

FIG. 10 shows an embodiment of a dental bone adhesive applicator 40 with a mixer 44 comprising a mixing head 441 which is collapsible in radial direction of the housing 41.

The spatial extent of the mixing head 441 can therefore be varied transverse to the longitudinal axis L of the housing 41. The mixing head 441 comprises a brush 4411 with biodegradable bristles. The bristles of the brush 4411 are mounted onto a shaft 4422 of the connector 442. The bristles of the brush 4411 may be bended against the shaft 442 in order to achieve the radial collapsibility.

The mixing head 441 is inserted into the mixing compartment 42 through the outlet 411 by taking advantage of the radial collapsibility of the brush 4411. Prior to insertion of the mixing head 441, a cap 46 with a central opening is mounted onto the outlet 411 in order to minimize or reduce leakage of the components of the bone adhesive while mixing. The mixing head 441 is inserted through the central opening of the cap 46.

The connector 442 comprises at its distal end a drive interface 4421 which is arranged outside of the housing 41. Thus, a drive, for example a drive of a dental handpiece, may be connected to the drive interface 4421 from the side of the outlet 411. By rotating and/or vibrating the brush 4411, mixing of the components of the bone adhesive can be performed.

After mixing the components of the bone adhesive, the mixing head 441 may be removed from the mixing compartment taking again advantage of the radial collapsibility of the brush 4411. The cap 46 may then be removed from the outlet 411 and the bone adhesive conveyed out of the mixing compartment 42 by advancing the plunger 43 towards the outlet 411. The plunger is pushed by a plunger rod 432 fixedly mounted to the plunger 43.

In some embodiments, a dental bone adhesive applicator corresponding to the dental bone adhesive applicator 40 as shown in FIG. 10 is provided without a cap 46. In such embodiments, the outlet 411 may exhibit a smaller cross-section in order to reduce leakage during mixing.

Before introducing the mixing head 441 into the mixing compartment 42, the mixing compartment comprises the one or more dry components of the bone adhesive. The liquid component may be introduced by using a reservoir corresponding to the reservoir as described in connection with FIGS. 1-3.

1-26. (canceled)

27. A bone adhesive applicator for mixing at least two components of a bone adhesive and applying the bone adhesive, comprising a housing with a longitudinal axis and an outlet, a mixing compartment arranged in the housing and in fluidic communication with the outlet, an axially movable plunger arranged in the housing and axially delimiting the mixing compartment opposite to the outlet, a mixer configured to mix the two components of the bone adhesive in the mixing compartment, wherein the mixer comprises a collapsible mixing head and a connector connected to the collapsible mixing head, wherein the connector comprises a drive interface.

28. The bone adhesive applicator according to claim 27, wherein the collapsible mixing head is collapsible in radial direction of the housing.

29. The bone adhesive applicator according to claim 28, wherein the collapsible mixing head comprises a brush.

30. The bone adhesive applicator according to claim 29, wherein the brush comprises bristles made of a biodegradable material.

31. The bone adhesive applicator according to claim 28, wherein the connector is guided through the outlet such that the drive interface is arranged outside of the housing.

32. The bone adhesive applicator according to claim 27, wherein the collapsible mixing head is collapsible in axial direction of the housing.

33. The bone adhesive applicator according to claim 32, wherein the mixing head is collapsible by movement of the plunger towards the outlet and expandable by movement of the plunger away from the outlet.

34. The bone adhesive applicator according to claim 33, wherein the plunger comprises a feedthrough for the connector, wherein the connector comprises a shaft guided through the feedthrough, the shaft comprising a proximal end connected to the mixing head and a distal end connected to the drive interface, wherein the shaft is rotatable around its shaft axis.

35. The bone adhesive applicator according to claim 27, wherein the collapsible mixing head comprises a helical spring.

36. The bone adhesive applicator according to claim 35, wherein the helical spring of the mixing head exhibits at least two different transverse diameters along its longitudinal spring axis.

37. The bone adhesive applicator according to claim 36, wherein one or more portions of the helical spring exhibit a monotonously decreasing diameter towards the plunger or towards the outlet.

38. The bone adhesive applicator according to claim 32, wherein the mixing head is collapsible by rotation of the mixing head in a first direction and expandable by rotation of the mixing head in a second direction opposite the first direction.

39. The bone adhesive applicator according to claim 38, wherein the mixing head comprises a turbine with blades which are switchable to an open configuration when the turbine rotates in the first direction and to a closed position when the turbine rotates in the second direction.

40. The bone adhesive applicator according to claim 39, wherein the turbine is configured as a plunger in the closed position of the blades, wherein the connector comprises a rotatable shaft which is connected to the turbine in a manner to rotate the turbine and to move the turbine in axial direction.

41. The bone adhesive applicator according to claim 27, wherein the drive interface is configured for connection with a dental handpiece.

42. The bone adhesive applicator according to claim 27, further comprising a plunger rod which is releasably connectable to the plunger.

43. The bone adhesive applicator according to claim 42, wherein the plunger rod comprises a recess dimensioned to receive the drive interface.

44. The bone adhesive applicator according to claim 27, wherein the bone adhesive applicator is a dental bone adhesive applicator for mixing a bone adhesive powder with a liquid to obtain a dental bone adhesive and applying the dental bone adhesive.

45. A bone adhesive applicating system comprising the bone adhesive applicator according to claim 27 and a reservoir with a reservoir housing and a reservoir outlet, wherein the mixing compartment of the bone adhesive applicator comprises a bone adhesive powder, and the reservoir comprises a liquid, wherein the reservoir outlet is connectable to the outlet of the bone adhesive applicator.

46. The bone adhesive applicating system according to claim 45, wherein the reservoir has a smaller volume than the mixing compartment when the liquid and the bone adhesive powder are separated.

47. A method for preparing a bone adhesive, comprising the steps of:
providing a bone adhesive applicating system according to claim 45;
supplying the liquid from the reservoir to the mixing compartment;
connecting a drive to the drive interface of the connector;
mixing the liquid with the bone adhesive powder in the mixing compartment by actuating the mixer using the drive.

48. The method according to claim 47, wherein the drive is a drive of a dental handpiece.
